(19) United States
(12) Patent Application Publication
(10) Pub. No.: US 2009/0249198 A1
(43) Pub. Date: Oct. 1, 2009

(54) TECHNIQUES FOR INPUT RECOGNITON AND COMPLETION

(75) Inventors: Marc Eliot Davis, San Francisco, CA (US); Joseph O'Sullivan, Oakland, CA (US); Christopher Todd Paretti, San Francisco, CA (US); Ronald Martinez, San Francisco, CA (US); Chris W. Higgins, Portland, OR (US); Athellina Athsani, San Jose, CA (US); Marco Boerries, Los Altos Hills, CA (US); Edward Stanley Ott, IV, Sunnyvale, CA (US); Keith David Saft, San Francisco, CA (US); George Grinsted, Stockholm (SE); Lee John Parry, London (GB); Ben Kim, Sunnyvale, CA (US); Steven Antonio Jackson, II, San Francisco, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/183,918

(22) Filed: Jul. 31, 2008

Related U.S. Application Data
(60) Provisional application No. 61/041,525, filed on Apr. 1, 2008.

(51) Int. Cl. G06F 3/048

(52) U.S. Cl. 715/261

(57) ABSTRACT

Methods and apparatus are described by which one or more input words may be predicted based on partial input from a user using a predictive model that employs contextual metadata which characterizes the user in a multi-dimensional space in which the dimensions are defined by one or more of a spatial aspect, a temporal aspect, a social aspect, or a topical aspect.

### RELATED APPLICATION DATA

The present application claims priority under 35 U.S.C. 119(e) to U.S. Provisional Patent Application No. 61/041,525 for TECHNIQUES FOR INPUT RECOGNITION AND COMPLETION filed Apr. 1, 2008 (Attorney Docket No. YAH1P159P/Y04400US00), the entire disclosure of which is incorporated herein by reference for all purposes.

### BACKGROUND OF THE INVENTION

The present invention relates to techniques for improving the efficiency with which text may be entered and, in particular, to improved techniques for input recognition and completion.

T9, which stands for Text on 9 keys, is a predictive text technology for mobile phones, the objective of which is to make it easier to type text messages. Using a predictive model to “guess” the most likely word(s) being entered by the user, T9 allows words to be entered by a single key press for each letter, as opposed to the multi-tap approach used in the older generation of mobile phones in which several letters are associated with each key, and selecting one letter often requires multiple key presses. It combines the groups of letters on each phone key with a fast-access dictionary of words. As it gains familiarity with the words and phrases the user commonly uses, it speeds up the process by offering the most frequently used words first and then lets the user access other choices with one or more presses of a predefined Next key. The dictionary can be expanded by adding missing words, enabling them to be recognized in the future. After introducing a new word, the next time the user tries to produce that word T9 will add it to the predictive dictionary. Examples of such predictive text technology and related predictive models are described in U.S. Pat. No. 6,801,190, U.S. Pat. No. 7,088,345, U.S. Pat. No. 7,277,088, and U.S. Pat. No. 7,319,957, the entire disclosure of each of which is incorporated herein by reference for all purposes. Unfortunately, in reality the probability that a user will type in a given string is not merely conditioned on the kinds of metrics T9 takes into account.

### SUMMARY OF THE INVENTION

According to the present invention, methods and apparatus are described for providing at least one input word based on partial input from a user. According to one class of embodiments, based on the partial input received from the user, probabilities for possible input words are determined with reference to contextual metadata representing a context associated with the user. At least one input word selected from among the possible input words with reference to the probabilities is transmitted to the user.

According to another class of embodiments, entry of the partial input by the user is facilitated. Presentation to the user of at least one input word selected from among a plurality of possible input words with reference to probabilities associated with each is then facilitated. The probabilities for the possible input words were determined based on the partial input with reference to contextual metadata representing a context associated with the user.

According to yet another class of embodiments, a first interface configured to receive the partial input from the user is presented. A second interface is then presented including at least one input word that represents at least one probable completion of the partial input and reflects contextual metadata representing a context associated with the user.

A further understanding of the nature and advantages of the present invention may be realized by reference to the remaining portions of the specification and the drawings.

### BRIEF DESCRIPTION OF THE DRAWINGS

FIG. 1 is a flowchart illustrating operation of a particular class of embodiments of the present invention.

FIGS. 2-4 are screen shots illustrating operation of various embodiments of the invention.

FIG. 5 is a simplified network diagram representing a computing environment in which embodiments of the present invention may be implemented.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

As mentioned above, the probability that a user will type in a given string is not merely conditioned on the kinds of metrics conventional techniques typically take into account. That is, in addition to metrics like the frequency of use for specific words in the English language, and the grammatical or syntactical rules employed, for example, by the T9 predictive model, there is a wide variety of contextual information which can potentially have significant, even dominant effects, on predictive accuracy.

Therefore, according to various embodiments of the invention, any predictive model by which input (e.g., text or speech) recognition and/or completion may be effected (including, but not limited to the T9 model) may be enhanced to include contextual metadata in its predictive analysis, and to thereby improve predictive accuracy. According to specific embodiments, one or more input words are predicted based on partial input from a user using a predictive model which employs contextual metadata which characterizes the user in a multi-dimensional space in which the dimensions are defined by one or more of a spatial aspect, a temporal aspect, a social aspect, or a topical aspect. The partial input from the user may occur in a wide range of application including, for example, messaging applications (e.g., text messaging), search applications (e.g., search query suggestion completion), etc. Virtually any application in which a user enters words or text may be enhanced using contextual metadata in accordance with embodiments of the invention.

Contextual metadata, also referred to herein as W4 metadata, include metadata which relate to one or more of the “Where,” the “When,” the “Who,” and/or the “What” of any given event, e.g., a text message, a voice communication, etc. That is, W4 metadata may include information which is spatial or geographic in nature (i.e., the “Where”), temporal (i.e., the “When”), social (i.e., the “Who”), and/or topical (i.e., the “What”). In addition, the relevance of at least some of these aspects may be determined by analyzing the similarity of these aspects among user groups, as well as patterns of these similarities within and among the respective spatial, temporal, social, and topical aspects.

Spatial information may be determined with reference to, for example, location and/or proximity data associated with mobile devices, GPS systems, Bluetooth and other beacon-based sensing systems, etc. Temporal information, e.g., the current time for a given geographic location, is also widely available in the various systems in which embodiments of the invention may be implemented. Social information may be determined with reference to a wide variety of sources, and may relate to the user currently enjoying benefits of the invention, as well as other users with whom the user is communicating, or with whom the user has some form of social relationship. Various social metadata which may be employed with embodiments of the invention are described in U.S. patent application Ser. No. 12/069,731 for IDENTIFYING AND EMPLOYING SOCIAL NETWORK RELATIONSHIPS filed Feb. 11, 2008 (Attorney Docket No. YAH1P134/Y04232US01), the entire disclosure of which is incorporated herein by reference for all purposes. Topical information related to a contact is available from a variety of sources including, but not limited to, the content of the communications between or among contacts as well as explicit profile data (e.g., declared interests) expressed in a user profile.

Additional techniques for generating and employing contextual data, i.e., W4 metadata, which may be employed with embodiments of the invention are described in U.S. patent application Ser. No. 11/593,869 for CONTEXT SERVER FOR ASSOCIATING INFORMATION BASED ON CONTEXT filed on Nov. 6, 2006 (Attorney Docket No. 324212013100/Y01528US00), Ser. No. 11/593,668 for CONTEXT SERVER FOR ASSOCIATING INFORMATION WITH MEDIA OBJECTS BASED ON CONTEXT filed on Nov. 6, 2006 (Attorney Docket No. 324212016200/Y01528US01), and Ser. No. 11/672,901 for CONTEXT-BASED COMMUNITY-DRIVEN SUGGESTIONS FOR MEDIA ANNOTATION filed Feb. 8, 2007 (Attorney Docket No. YAH1P073/Y01902US01), the entire disclosure of each of which is incorporated herein by reference for all purposes.

A specific embodiment of the present invention, referred to herein as T13, relates to an implementation in which a predictive model (e.g., the T9 predictive model or a similar model) is enhanced in accordance with the invention, and used to recognize and/or complete text or speech input. The main idea behind T13 (derived from T9+W4) is that certain words, or even phrases, are more likely in some contexts than others. For example, the predictive model employed by T9 assigns extremely low probability to proper names. However, there are certain contexts in which particular proper names are highly likely to be used in communications. For example, at a U2 concert, the name of the lead singer, “Bono,” is highly likely to be entered by a user in a text message.

Conversely, if the user is known to be near a military firing range, the same set of key strokes which map to “Bono” might more likely map to “ammo” or “boom.” Knowing where the user is and the current time (e.g., from the user's mobile phone) in combination with other information (e.g., data relating to a scheduled U2 concert at that location and time) enables addition contextual input to the predictive model regarding the likelihood of this text string which then may then result in it being offered as a suggestion or auto-complete string to the user. And as will be discussed, the social relationships of the user generating the message as well as the recipient of the message may also be used to enhance a predictive model in accordance with the invention.

In addition to the place and time associated with the particular user and/or the message recipient, the behavior of other users at the same or similar place and time may be used to enhance the predictive model. That is, the increased frequency with which other users (whether related to the first user or not) are currently or recently texting the string “Bono” may be used to boost the likelihood of that string in the enhanced predictive model.

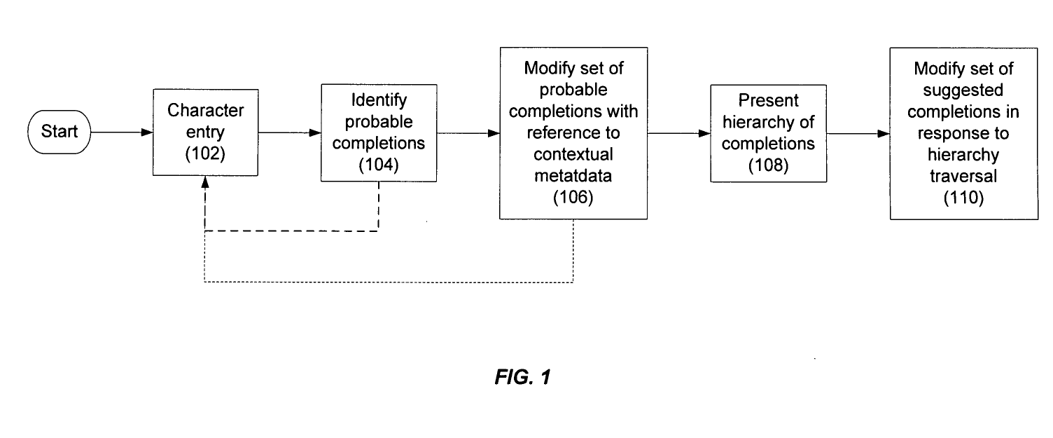

An example of the operation of a specific embodiment of the invention is illustrated in the flowchart of FIG. 1. In this example, a user is initiating a text message. As the user begins entering characters (102), the system computes the probabilities of various character sequences using one or more conventional parameters typically employed by conventional predictive models, e.g., T9, such as, for example, word usage frequency, common word usage in a specific language, etc. (104). Contextual metadata are then used to disambiguate the probable terms and/or enhance the computed probabilities (106). 102 and/or 104 may begin with, for example, the third character entered, and may be iterated with each successive character (as indicated by the dashed lines).

It should be noted that embodiments are contemplated in which the use of contextual metadata is integrated within a single predictive model rather than as a secondary enhancement or disambiguation phase as described above. That is, the present invention relates generally to the use of such contextual metadata to effect input recognition and/or completion, regardless of whether such use is part of an integrated predictive model, or in conjunction with a separate predictive model (e.g., the T9 model).

And regardless of how contextual metadata are incorporated into a process enabled by the present invention, the user's spatial, temporal, and/or social conditions may be used in a wide variety of ways. In addition, the word usage of other users (whether or not related to the user entering the text) in similar spatial and/or temporal conditions may be used to inform a predictive model enhanced by the present invention. In some embodiments, word usage by other users in the same context as the user, i.e., in the user's immediate proximity, may be used. Similarly, contextual metadata associated with a message recipient may be used.

According to a particular class of embodiments, the system tracks the word usage of a user and creates a dynamic language model specific to that user which incorporates the understanding of the user's spatial, temporal and/or social conditions (or combinations thereof). Alternatively or in addition, the dynamic language model and tracked word usage could be specific to a particular context rather than a specific user. More generally, a system designed in accordance with such embodiments is operable to create multiple models based on W4 data collected from virtually any source. That is, W4 contextual metadata may be used not only to provide the right sequence of words (including proper names) or word predictability in a given context, but also to create and update the aggregation of language models for any given spatial, temporal and/or social context involving the user, the recipient of the message, and/or the social context surrounding the user and/or recipient.

According to various embodiments, a wide variety of opportunities to monetize embodiments of the invention exist. For example, monetization could occur through the sponsorship of proper names, e.g., “The correct spelling of Starbucks brought to you by Starbucks.” Appropriate tooltips and links (which might be monetized using conventional mechanisms like “cost per click”) could be provided in response to the recognition of proper names. Auto-completion or word recommendation could be biased towards sponsor names, with specific sequences of keystrokes being bid upon by sponsors in much the same way as advertising keywords. For example, in response to a user attempting to enter “coffee,” text recommendations such as “Peet's” or “Starbucks” could be provided. Alternatively or in addition, entering “coffee” might bring up tooltips and/or links to the closest coffee shop. Bidding on common misspellings or abbreviations could also be provided. For example, if a user begins entering “ammzon” the text recommendation “ebay” could be provided. As will be understood, these are merely a few examples of the wide variety of ways in which embodiments of the invention may be monetized.

In some embodiments, the socio-linguistic concept of “lects” may be employed in conjunction with social metadata to enhance predictive models according to the invention. A “lect” refers to a localized language usage cluster, e.g., dialect, ethnolect, sociolect, which include words and syntax commonly used by the relevant group. Thus, if a particular user (and/or the recipient of a message generated by the user) is part of an identifiable social group, the term frequencies for that specific group may be used in the predictive model rather than the more general (and likely less applicable) statistics that are employed by conventional models (e.g., the T9 predictive model).

Input recognition and completion techniques enabled by the present invention need not merely complete text being entered by the user, but may also alter text or make suggestions regarding vocabulary with reference to W4 metadata. For example, frequent users of text messaging services have adopted a wide variety of abbreviations for commonly used phrases. However, less frequent users may not be aware of all of these conventions. So, for example, if a father is texting his daughter and intends to sign off with the phrase “talk to you later,” a predictive model enhanced with an understanding of the audience, i.e., teenage daughter, may “complete” the entire phrase with the suggested abbreviation “ttyl” in response to the entering of the first letter or first few letters of the word “talk.” Conversely, if the other party to the communication happens to be a business associate, the phrase “ttyl” could be “completed” with a suggested and grammatically cleansed “I will talk to you later.” These are additional examples in which the social relationship with the recipient(s) and the identity and/or W4 metadata of the recipient(s) may be taken into account in making the appropriate suggestions and/or completions.

In another example along the same lines, the same message may be “completed” and presented differently to different recipients. In the example above, where the sender of the message begins entering “ttyl,” the message may be completed and presented to his daughter as “ttyl,” but to his wife as “talk to you later.”

In addition to a message recipient's W4 metadata being taken into account in predictive models enhanced according to the invention, embodiments are contemplated in which W4 metadata associated with individuals to whom the message is not directed may be taken into account. For example, if it can be determined that the sender of a message is in the company of one or more individuals at a particular physical location, and the identities of those individuals are identifiable, e.g., using similar mechanisms as those which enabled identification of the user himself, then W4 metadata relating to those other individuals may be taken into account when recognizing and suggesting or completing input.

It should be understood that the use of W4 metadata to enhance predictive models similar to the T9 predictive model is merely one class of embodiments of the present invention, and that such contextual metadata may be used to enhance the accuracy of predictive models in a wide variety of input recognition and/or completion applications. For example, another class of embodiments of the present invention is contemplated in which a predictive model enhanced with reference to W4 metadata may be used to disambiguate search queries which map to multiple concepts or result types (e.g., the query “apple” maps to a tech company, a record label, and a fruit). That is, contextual information associated with the user entering a given search query can be used to predict the concept or entity to which the query is actually directed, and therefore inform the presentation of search query suggestions as well as relevant search results. Additional information about the operation of a process for disambiguating queries which may be enhanced by the use of W4 metadata may be obtained with reference to U.S. patent application Ser. No. 11/651,102 for CLUSTERED SEARCH PROCESSING filed on Jan. 5, 2007 (Attorney Docket No. 08226/0205903-US0), the entire disclosure of which is incorporated herein by reference for all purposes.

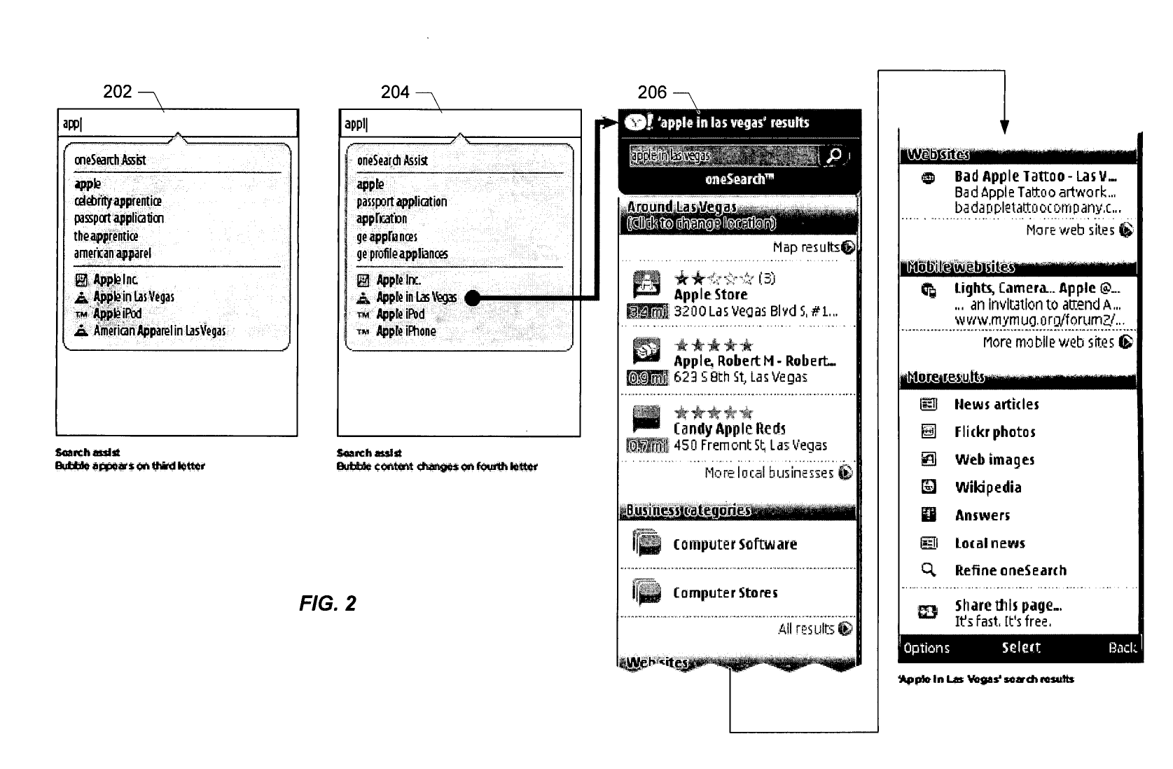

Mobile device screen shots illustrating examples of query disambiguation and query suggestion/completion enabled by the present invention are provided in FIGS. 2-4. In these examples, referred to collectively as Search Assist, query recognition, completion, and suggestion, as well as presentation of search results are enhanced and/or biased using W4 metadata. For example, in screen 202, in response to the characters “app,” a bubble showing suggested completions of the query is generated and includes a first section of suggestions derived with reference to query log frequencies, and a second section of suggestions listing different entity types to which the query might resolve. This entity resolution might be achieved, for example, as described in U.S. patent application Ser. No. 11/651,102 incorporated by reference above. In screen 204, the addition of one character to make the input string “appl” results in a refinement of the suggested completions. According to embodiments of the present invention, the suggested completions in one or both sections may be biased with reference to W4 metadata.

According to a specific embodiment, the suggested completions are generated using a predictive model enhanced with W4 metadata. In the example of FIG. 2, the user's location has been identified as Las Vegas, so the entity suggestions include entities in Las Vegas. And because the user selects “Apple in Las Vegas” in screen 204, the results in screen 206 include the Las Vegas Apple store as the first result.

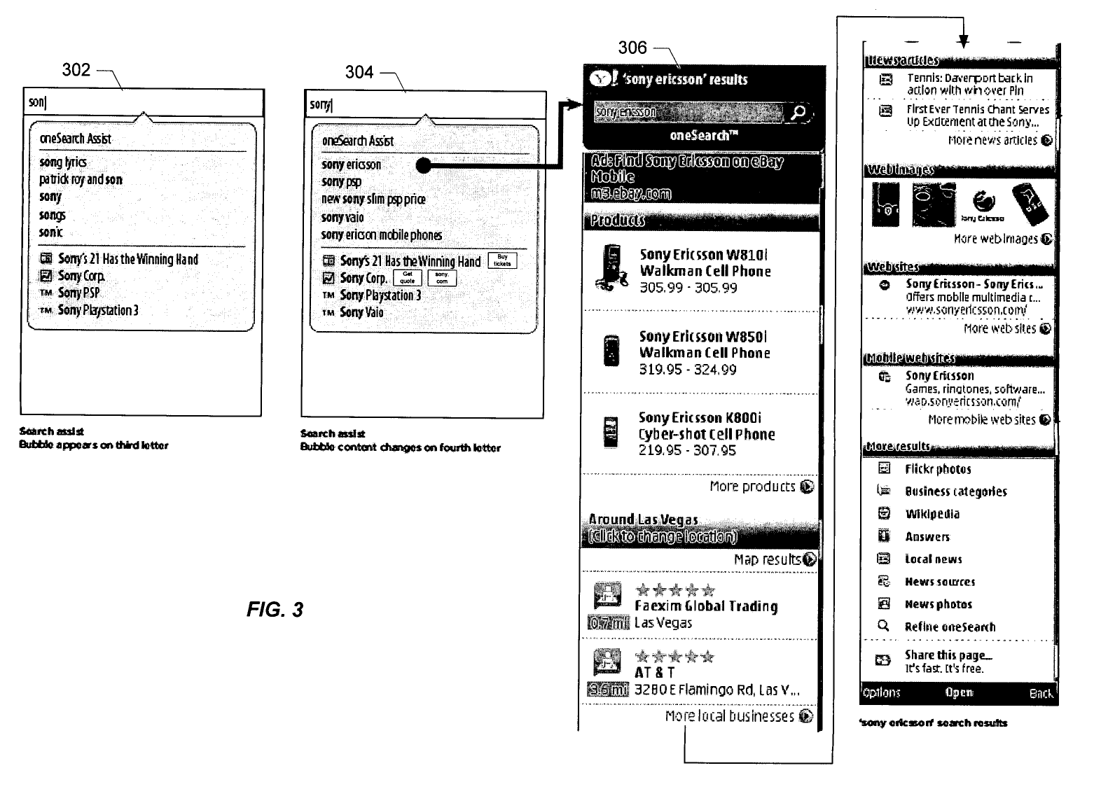

Screens 302, 304, and 306 of FIG. 3 illustrate another example in which the suggestions in response to the string “son” are presented in different sections (e.g., query log frequency and entity resolution), refined in response to an additional character, i.e., “sony,” and enhanced using W4 metadata. In response to selection of “sony ericsson,” the first cluster of responses relates to Sony Ericsson products.

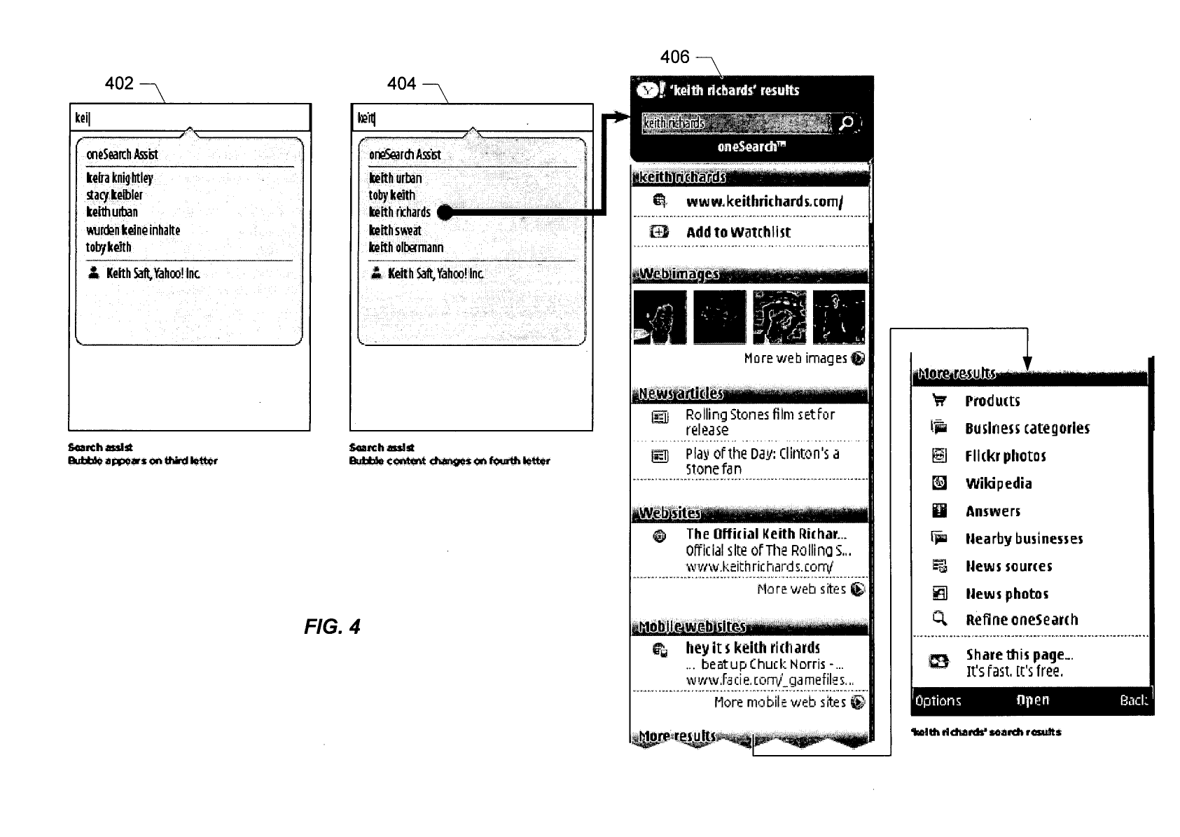

Screens 402, 404, and 406 of FIG. 4 illustrate yet another example in which query completion suggestions are made using W4 metadata in response to the strings “kei” and “keit.” Selection of the query “keith richards” results in presentation of clusters of different types of search results relating to the iconic rock guitarist. In this example, using W4 metadata, the input string is also mapped to an entity “Keith Saft” who is a contact of the user entering the string. Identification of this entity might involve, for example, a reference to a local address book on the user's device. According to one embodiment, the connection between the user and the contact might be derived according to the techniques described in U.S. patent application Ser. No. 12/069,731 incorporated herein by reference above.

Other entities which may be presented as suggested query completions could represent “smart bookmarks” as described in U.S. Patent Application No. [unassigned] for MECHANISMS FOR CONTENT AGGREGATION, SYNDICATION, SHARING, AND UPDATING (Attorney Docket No. YAH1P155/Y04375US01), the entire disclosure of which is incorporated herein by reference for all purposes. So, for example, if the user typing in the string “keit” had an existing “smart bookmark” for Keith Richards, this could be included in the list of entity suggestions, e.g., below the one for Keith Saft.

According to specific embodiments, the presentation of suggested query completions as well as search results may be coupled with a sponsorship model similar to sponsored search results. So, for example, in addition to the use of a W4-enabled predictive model to bias suggested completions and/or results, the suggested completions and/or results may also include sponsored suggestions and sponsored results. In the example of screen 304, the inclusion of “sony ericsson” and/or its position in the list of suggested queries may be biased with reference to such paid sponsorships. In addition, or alternatively, and like sponsored search results, sponsored suggestions or completions may be identified as such and/or segregated from algorithmic or other results.

Embodiments of the invention are contemplated in which suggested query completions are presented in a wide variety of ways. As discussed above, the examples shown in FIGS. 2-4 show the suggestions segregated into two types, e.g., suggestions derived from query logs, and suggestions derived by entity resolution. According to one class of embodiments, the suggested completions which are responsive to a particular input string may be clustered into groups in which the member suggestions are highly correlated. According to some embodiments, this correlation may be derived with reference to the fact that the queries in each group resolve to a particular uniquely identified entity or concept. According to others, this correlation may be derived with reference to co-occurrence, i.e., how commonly the keywords in particular queries show up in the same documents. According to still other embodiments, this correlation may be derived with reference to more simple or straightforward techniques such as, for example, character overlap between queries. As will be understood, these as well as other techniques for determining correlations between and among queries may be used, alone or in various combinations, to effect clustering of suggested query completions.

According to some embodiments, clusters or types of suggested query completions may be organized in a hierarchy. In some of these embodiments, mechanisms are provided in which the user can navigate the hierarchy to refine or modify the set of suggested query completions. An example may be instructive. If a user enters the string “sus,” among the suggested completions might be the suggestion “sushi restaurants” or a cluster of specific sushi restaurants under the heading “sushi restaurants.” “sushi restaurants” may further be part of a hierarchy in which “Japanese restaurants” is a super-category which includes “sushi restaurants,” and in which “vegetarian sushi restaurants” is a sub-category. In this example and as shown in the flowchart of FIG. 1, the user may be provided with a user interface feature which presents a navigable representation of this hierarchy which enables him to traverse the hierarchy (108), in response to which the set(s) of suggested query completions will change with selection of different suggested query completions accordingly (110). For example, by traversing to the super-category, the suggested completions will be broadened to include suggested queries relating to Japanese restaurants rather than just sushi restaurants. Conversely, traversing to the sub-category will refine or filter the suggested query completions to include suggested queries relating to sushi restaurants which offer vegetarian options. Thus, in addition to W4-enabled suggestion/completion, embodiments of the invention are contemplated in which suggested query completions are enabled using knowledge of a semantic hierarchy which interrelates the suggested query completions.

According to specific embodiments of the invention, suggested query completions or suggested queries may be accompanied by additional information, control objects, and/or links which allow the user to initiate specific actions. According to one set of embodiments, a suggested query may be presented as a triplet which includes an indicator of a corresponding entity or result type, a string of text including the current partial input provided by the user, and some mechanism or link to initiate an associated action. So, for example, referring to screens 302 and 304 of FIG. 3, the suggested query relating to Sony Pictures new film “21” has an icon to its left which indicates that this suggested query corresponds to movie reviews. In addition and as shown, an object or icon may be presented to the right of the suggested query which allows the user to take specific actions relating to the film, e.g., buy tickets, view trailer, etc. Similarly, the stock chart icon to the left of “Sony Corp.” indicates the entity type as corporation or company. Possible user action icons which may be presented in association with such a suggested query might include, for example, objects or icons which allow the user to get a stock quote, go to the company's web site, etc.

According to some embodiments, suggested query completions as well as search results may be biased or presented with reference to things like device type, bandwidth constraints, service plan type, carrier, etc. For example, suggested queries on a mobile device with limited bandwidth might be biased toward queries which would elicit news articles rather than videos. Conversely, a high bandwidth device might have such suggested queries biased toward video rather than text. The bias could be in what kinds of suggested queries or search results are presented and/or the order in which different types of suggested queries or search results are presented. Suggested queries or search results might also be enhanced to include information to enable the user to make an informed choice with regard to such constraints. For example, a suggested query or search result could be enhanced to include the media type to which the query or result is directed, and specific information such as file size, download time, cost to download, required bandwidth, etc. In this way, the user can select suggested queries and/or search results with an understanding of how efficient or expensive the transaction will likely be.

In another class of embodiments, W4 metadata are used to enhance a predictive model which is used to automatically complete or suggest addressees of messages such as, for example, emails, text messages, etc. That is, for example, based on the current context (spatial, temporal, social, and/or topical) of a user constructing an email, as well as a variety of other information (e.g., past communication patterns, subject matter of communication (e.g., based on subject line or message body), etc.), a predictive model enhanced with relevant W4 metadata (e.g., of the sender and/or the recipient) can suggest and/or complete addressee information. For example, if a user is at work and is constructing a relatively long email that includes little or no shorthand abbreviations, this information may be used to bias address suggestion and/or completion toward work associates or professional contacts. Conversely, if analysis of the content of the email indicates that it is not intended as a professional communication, e.g., liberal use of shorthand, professionally inappropriate language, etc., address suggestion and/or completion may be biased toward friends and personal contacts.

In yet another class of embodiments, predictive models enhanced with W4 metadata may be employed to enhance the operation of virtually any application requiring user input, and user interaction with virtually any type of device. One class of examples relates to word processing, document production, or text generation software. For example, a user's W4 metadata may be employed to suggest vocabulary, correct spellings, grammatical constructions, etc., while the user is generating a word processing document, producing a presentation deck, composing the body of an email, entering text in an online form, etc. For example, the input string “hiya wher r we mtg 2mrw?” could be mapped to “Could you please let me know where we are meeting tomorrow?” for a recipient who is a professional superior, to “Hi there. Where are we meeting tomorrow?” for a recipient with whom the message sender is not particularly close, and remain unchanged for users with whom the message sender has a close personal relationship. This contextual information could be derived, for example, with reference to social relationship data (including conventional address books, latent and explicit social network relationship data, etc.).

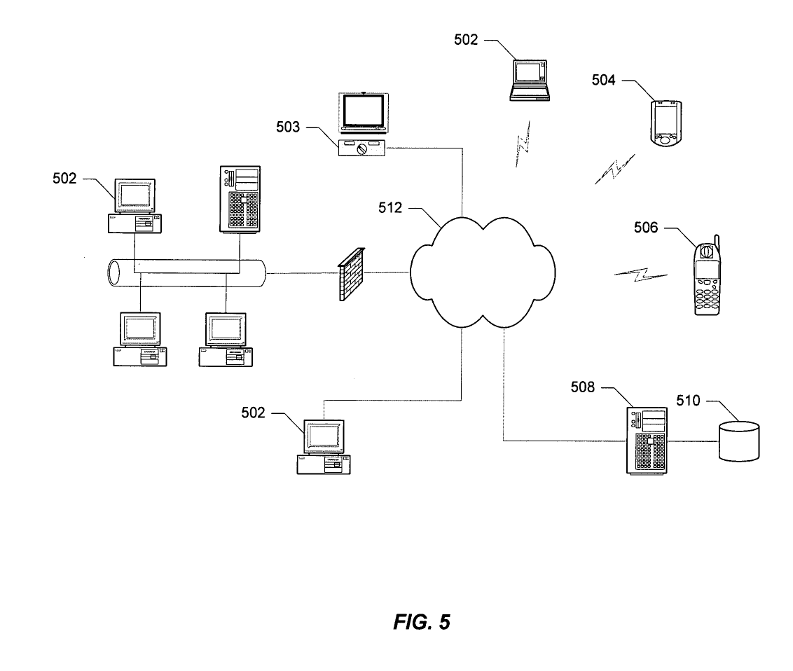

Embodiments of the present invention may be employed to effect input recognition and completion in any of a wide variety of computing contexts. For example, as illustrated in the network diagram of FIG. 5, implementations are contemplated in which the relevant population of users interacts with a diverse network environment via any type of computer (e.g., desktop, laptop, tablet, etc.) 502, media computing platforms 503 (e.g., cable and satellite set top boxes and digital video recorders), mobile computing devices (e.g., PDAs) 504, cell phones 506, or any other type of computing or communication platform.

And according to various embodiments, user data and W4 metadata processed in accordance with the invention may be collected using a wide variety of techniques. For example, collection of data representing a user's interaction with a web site or web-based application or service may be accomplished using any of a variety of well known mechanisms for recording, analyzing, or tracking a user's online behavior. User data may be mined directly or indirectly, or inferred from data sets associated with any network or communication system on the Internet. And notwithstanding these examples, it should be understood that such methods of data collection are merely exemplary and that user data may be collected in many ways.

Once collected, the user data may be processed, or services employing such data may be provided in some centralized manner. This is represented in FIG. 5 by server 508 and data store 510 which, as will be understood, may correspond to multiple distributed devices and data stores. The invention may also be practiced in a wide variety of network environments including, for example, TCP/IP-based networks, telecommunications networks, wireless networks, etc. These networks, as well as the various social networking sites and communication systems from which connection data may be aggregated according to the invention are represented by network 512.

In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for providing at least one input word based on partial input from a user, comprising:
receiving the partial input from the user;
determining probabilities for possible input words based on the partial input with reference to contextual metadata representing a context associated with the user; and
transmitting to the user the at least one input word selected from among the possible input words with reference to the probabilities.

2. The method of claim 1 wherein the partial input corresponds to one of electronic message text, an address field entry, a search query, word processing document text, online form text, application input, or a device interaction.

3. The method of claim 1 wherein the at least one input word comprises one or more of a suggested word, a suggested phrase, a suggested search query, a suggested address, a suggested syntax, a suggested spelling, or a suggested grammatical construction.

4. The method of claim 1 wherein determining the probabilities for the possible input words comprises determining preliminary probabilities using a predictive model, and revising the preliminary probabilities with reference to the contextual metadata.

5. The method of claim 1 wherein determining the probabilities for the possible input words comprises using a predictive model which includes the contextual metadata.

6. The method of claim 1 wherein determining the probabilities for the possible input words comprises using a predictive model based on a language usage cluster corresponding to a group of which the user is a part.

7. The method of claim 1 wherein determining the probabilities for the possible input words comprises using a dynamic language model specific to the user and based on tracked word usage by the user.

8. The method of claim 1 wherein determining the probabilities for the possible input words comprises using a dynamic language model specific to the context and based on tracked word usage associated with the context.

9. The method of claim 1 wherein the contextual metadata represents one or more of user information associated with the user, a social relationship associated with the user, a current geographic location associated with the user, a current time associated with the user, a current topic, recipient information associated with a recipient of a message from the user, word usage by other users having similarities to the user, content in a body of text associated with the user, device type, bandwidth constraints, service plan type, or carrier.

10. The method of claim 1 wherein the at least one input word is part of a semantic hierarchy including a plurality of input words, the method further comprising:
transmitting a representation of the semantic hierarchy including at least some of the plurality of input words;
facilitating navigation by the user within the semantic hierarchy; and
repeating the determining and transmitting in response to selection by the user of a different one of the plurality of input words in the semantic hierarchy.

11. A system for providing at least one input word based on partial input from a user, the system comprising at least one computing device configured to:
receive the partial input from the user;
determine probabilities for possible input words based on the partial input with reference to contextual metadata representing a context associated with the user; and
transmit to the user the at least one input word selected from among the possible input words with reference to the probabilities.

12. A computer-implemented method for providing at least one input word based on partial input from a user, comprising:
facilitating entry of the partial input by the user; and
facilitating presentation to the user of the at least one input word selected from among a plurality of possible input words with reference to probabilities associated with each;
wherein the probabilities for the possible input words were determined based on the partial input with reference to contextual metadata representing a context associated with the user.

13. The method of claim 12 wherein the partial input corresponds to one of electronic message text, an address field entry, a search query, word processing document text, online form text, application input, or device interaction.

14. The method of claim 12 wherein the at least one input word comprises one or more of a suggested word, a suggested phrase, a suggested search query, a suggested address, a suggested syntax, a suggested spelling, or a suggested grammatical construction.

15. The method of claim 12 wherein the contextual metadata represents one or more of user information associated with the user, a social relationship associated with the user, a current geographic location associated with the user, a current time associated with the user, a current topic, recipient information associated with a recipient of a message from the user, word usage by other users having similarities to the user, content in a body of text associated with the user, device type, bandwidth constraints, service plan type, or carrier.

16. The method of claim 12 wherein facilitating presentation of the at least one input word comprises one or more of facilitating completion of the partial input, facilitating alteration of the partial input, or facilitating separate presentation of the at least one input word as a suggestion.

17. The method of claim 12 wherein the at least one input word is part of a semantic hierarchy including a plurality of input words, the method further comprising:
facilitating presentation to the user of a representation of the semantic hierarchy including at least some of the plurality of input words;
facilitating navigation by the user within the semantic hierarchy; and
facilitating alteration of the presentation of the at least one input word in response to selection by the user of a different one of the plurality of input words in the semantic hierarchy.

18. The method of claim 12 further comprising facilitating presentation of at least one object in association with the at least one input word, the at least one object being configured to initiate an action associated with the at least one input word when selected by the user.

19. The method of claim 18 wherein selection of the at least one object by the user initiates a financial transaction.

20. The method of claim 12 further comprising facilitating presentation of a sponsorship indicator in association the at least one input word.

21. A computer-implemented method for providing at least one input word based on partial input from a user, comprising:
presenting a first interface configured to receive the partial input from the user; and
presenting a second interface including the at least one input word, the at least one input word representing at least one probable completion of the partial input and reflecting contextual metadata representing a context associated with the user.
